(19) United States
(12) Patent Application Publication
(10) Pub. No.: US 2018/0276772 A1
(43) Pub. Date: Sep. 27, 2018

(54) TOUR MATCHING AND GENERATING SYSTEM WITH METHOD

(71) Applicant: Yunlong Yi, Vancouver (CA)

(72) Inventor: Yunlong Yi, Vancouver (CA)

(21) Appl. No.: 15/467,961

(22) Filed: Mar. 23, 2017

(51) Int. Cl. G06Q 50/14; G06Q 30/06; G06Q 10/02

(52) U.S. Cl. CPC G06Q 50/14; G06Q 30/0621; G06Q 10/025; G06Q 30/0611; G06Q 30/0631

(57) ABSTRACT

A tour matching and generating system with method includes a platform for intelligent tour product booking and price comparison allowing users to customize tour products and request quotes in a timely manner. The tour matching and generating system uses browsing history and purchasing history to create customized user-preference oriented tour products. A tour route is intelligently created by the system based on user preference pattern combined with a result from big data analytics.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of electronic travel services and more specifically relates to a tour matching and generating system with method.

### 2. Description of Related Art

Traveling is a popular pastime. More and more people are purchasing goods and services electronically, such as over the Internet. Electronic exchange systems are achieving widespread use in the area of travel arrangements. These systems provide an outlet for suppliers having surplus inventory, and often allow consumers to obtain desired goods or services at below-market rates. Every year many travelers book private tours online or through travel agencies. Currently, private tours are either booked through travel agencies, different online travel agents, or by sending inquiries to different tour guides or agencies to get quotations. Normally, this will take an extended amount of time to get a satisfactory result, and consumers can't control the whole process. Sometimes, travelers end up choosing pre-packaged tours that may not fully satisfy their needs, or they may delay the trip. A suitable solution is desired.

U.S. Pat. No. 7,272,568 to Birch relates to a system and method for matching an offer with a quote. The described system and method for matching an offer with a quote includes a system and method for matching a customer's offer for travel services with quotes from providers of those travel services in a way that allows the providers to negotiate preferential treatment. An online travel service exchanger receives an offer from a customer for travel services, such as airfare. The online travel service exchanger attempts to satisfy the customer's offer by retrieving from a global distribution system one or more quotes for the identified travel services. Rather than merely requesting quotes from randomly selected airlines, the online travel service exchanger first requests quotes from one preferred airline at a time in descending order of preference until the offer is satisfied. If no preferred airline satisfies the offer, the online travel service exchanger may request quotes from a group of non-preferred airlines. The online travel service exchanger then satisfies, if possible, the offer with one of the quotes from the non-preferred airlines.

### BRIEF SUMMARY OF THE INVENTION

In view of the foregoing disadvantages inherent in the known electronic travel services art, the present disclosure provides a novel tour matching and generating system with method. The general purpose of the present disclosure, which will be described subsequently in greater detail, is to provide a tour matching and generating system with method.

Tour Product: in this patent application, the term is used to refer to existing tours or tour products in our system that have been pre-made by Kootour partners and not those machine-generated. Tour Route: in this patent application, the term refers to all machine-generated tour products offered to travelers and which are later sent out to providers found by the search engine in order for the traveler to receive a quotation on it.

A tour matching and generating system with method is disclosed herein. The present invention includes a means for analyzing a user's browsing activity, purchase history, and other related information to develop a user's tour preference pattern, a search engine for collecting tourism information from both internal and external sources and preforming relevant big data analytics, a data store that electronically stores information regarding tour products and tourism-related information in response to one or more electronic queries, and a computing device in communication with the data store. Big data analytics on tourism information involves a means for analyzing collected tourism information from both internal and external databases and identifying different patterns and/or trends on general population. The results obtained from big data analytics can be used for various purposes, including intelligent tour product matching and routes generating, content building such as writing blogs and newsletter to our members, and so forth.

This user-preference driven matching and generating system collects a user's behavioral data to analyze and match from the data store, and returns a plurality of preference-based tour products/routes to a user for possible purchase. The user may also customize a tour product/route according to his/her specifications and submit to the system. The system electronically sends out quotation requests to all qualified service providers and consolidates all replies into one report returning to the user for possible purchase.

In order to recognize user's preference pattern the system sets out to identify and establish user's travel preference pattern, by analyzing the user's browsing and purchase history on our product, as well as the questionnaire he/she filled during the first-time visiting regarding of his/her travel preference. The data will be collected via our system. When the user browses the application (also referred to as App, WebApp, and Native app), each time the user browses any inside pages (cities, tours, etc.) or searches on our App, our system's backend will record the page links or his/her searched items for further customer behavioral analyzing. Each time when this user purchases a tour from our site, the system will record the transaction details and analyze his/her purchased tour package to get a more precise tour preference. Also, if this user registers on the App, his/her wish list will be recorded by the system.

The system will analyze all collected data as described above, and establish a user's travel preference pattern. The more data is collected, the more precise the pattern is. Our system is constantly monitoring the user's behavior on our App and refining his/her preference pattern. Based on the preference pattern developed, the system is able to make prediction of what types of tours the user may like. If a user is an anonymous user (not a signed up user), our system's backend will use session to identify this person, and record this person's behavior into our system each time he/she visits our system. Next, the user browses our App, each time the user browses any inside pages (cities, tours, etc.) or searches on our App, our system's backend will record the page links or his/her searched items for further customer behavioral analyzing. Once an anonymous user has become a registered member, our system will link this anonymous user's preference records to his/her registered email account, so that all historical browsing records will be consolidated.

The first time a user logs in our App the system will display several groups of pictures for the user to select (or a questionnaire). The purpose of this is to get the user's travel preference.

A tour product refers to an existing tour or tour product offered by registered vendor. It is able to be customized by the user and in turn be quoted by the corresponding vendor.

A tour route is intelligently created by the system based on user preference pattern combined with the result from big data analytics; it may comprise several individual tours/activities. The tour routes are able to be customized by selecting and alternatively deselecting individual tours/activities from the itinerary. An estimated range of time and price changes may be displayed as the user changes tours and activities from the itinerary. This estimate is calculated by the system based on existing information stored in the data store which is collected by the search engine and/or provided by the registered vendors.

When a user searches for a specific destination where none of our registered vendors offer tour products in that area, the system starts generating several routes based on the big data analytic results to match the user's preference and specifications. Each system-generated route may comprise several individual tours/activities. An estimated price and time range for each tour/activity as well as the summation for the whole itinerary will be provided to the user. Each system-generated route is customizable. A user can add/delete or select/deselect specific tours/activities from the whole route. The user can also type in his/her specifications in the text field if none of the tours/activities satisfy his/her needs.

The system can identify a travel preference pattern from user's behavior based on all the data collected from the user, including his/her browsing and purchasing history, and the snapshot of his/her travel preference collected at the beginning. When the pattern is recognized, the system uses algorithms to predict what kind of tours/activities the user may like. In the mean time, the system uses the results obtained from big data analytics as a reference to list and organize all tour/activity information, for example, which tour is the most popular or which attraction is a must-visit spot in the city. Thus, by combining these analyses, the system will search in our database to grasp and collect corresponding tour/activity information, combine this useful data, and then generate several suggested routes. Each time when the user uses our system, his/her action is recorded and accumulated for further refinement of the prediction.

Each system-generated route is presented as a tour package; however, this route does not have any service providers associated with it. If the user wants to book this route, the system will help him/her to get quotation from qualified local travel service providers whom are searched out by our search engine. The system will send emails to the service providers requesting for quotations.

The data store comprises airfare options, hotel options, and activity options which are able to be selectively combined to create a tour product. A web crawler may be used to search and collect service provider's information and contact information of guides. The service providers may receive a tour product quotation e-mail for bidding. The service provider may respond to the e-mail and provide at least one quotation. The quotations received from the service providers are then consolidated into one e-mail to the user including price, name of providers, detailed itinerary, rankings, number of reviews, and other helpful information. Other options are also available based on the user's purchase history and browsing history version and a keywording embodiment is also available for use.

According to another embodiment, a tour matching and generating system with method is also disclosed herein. The method includes entering data by a user over a duration to create a purchase history and browsing history; using the purchase history and the browsing history to create a user-profile; logging in to the user-profile to search for tour products based on keywords; customizing the tour products; requesting quotes for the tour products from members; receiving quotes for suggested tour products to the user; and booking the tour product based on quotes.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a tour matching and generating system with method, constructed and operative according to the teachings of the present disclosure.

FIG. 1 is a diagram of the tour matching and generating system with method, according to an embodiment of the disclosure.

FIG. 2 is a diagram of the tour matching and generating system with method of FIG. 1, according to an embodiment of the present disclosure.

FIG. 3 is a diagram of the tour matching and generating system with method of FIG. 1, according to an embodiment of the present disclosure.

FIG. 4 is a diagram of the tour matching and generating system with method of FIG. 1, according to an embodiment of the present disclosure.

FIG. 5 is a diagram illustrating the tour matching and generating system with method, according to an embodiment of the present disclosure.

FIG. 6 is a diagram illustrating the tour matching and generating system with method, according to an embodiment of the present disclosure.

FIG. 7 is a diagram illustrating the tour matching and generating system with method, according to an embodiment of the present disclosure.

FIG. 8 is a diagram illustrating the tour matching and generating system with method, according to an embodiment of the present disclosure.

FIG. 9 is a diagram illustrating the tour matching and generating system with method, according to an embodiment of the present disclosure.

FIG. 10 is a diagram illustrating the tour matching and generating system with method, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to electronic travel services and more particularly to a tour matching and generating system with method as used to provide an intelligent tour matching service and price comparison system.

Generally, tour matching and generating system with method is a platform to build a user-preference based tour product allowing users to customize their own tours and get a quotation promptly. The present invention saves time and cost by collecting all prices and service information with a simple price comparison system eliminating the need to send out several emails or calls for inquiries. Clients will save time on searching online to find qualified tour service providers and save time on sending inquires to those tour service providers. The tour matching and generating system is designed to maximize clients' benefit by exposing requests to all potential tour service providers and encouraging them to quote for a client's itinerary. All quotes may then be consolidated into one table within an e-mail for the client.

A client is also able to see all customer reviews in one form. The user may save money by choosing and booking desired private tours based on the user's budget and previous customer reviews. The program will automatically suggest group size options and lower a user's cost by automatically suggesting to join other users if the system finds out there are similar requests at the same time. By doing so, it will also benefit tour service providers by: simplifying the registration and quotation process and save on costs by getting more customers when similar requests from different users are met.

An intelligent end-user preference pattern matching system may be used to identify the end user's travel preference, by analyzing the user's purchase history and browsing activity. These records may come from our data and/or other similar service websites. As the user continues using the services, the system automatically records and accumulates the user's activity for further refinement of his or her preference pattern.

Users may connect their account to other tourism related or social related websites and retrieve previous purchasing, booking information or their travel preference. By doing so, the program may identify the user's preference by consolidating all the historical information, for example, what kind of airline the user prefers, which grade of hotel the user prefers, what kind of tours and activities (relax, adventure, natural view, hiking and sports, etc.) the user prefers, etc.

In another embodiment of the present invention, when the user wants to book some tours, the user may input some keywords for that service, and the system will automatically match the tour products information in the database based on the user's preference pattern combined with the results from big data analytics and then list the top popular tour products offered by registered vendors with higher priority and/or generate tour routes based on the user's keyword of destination where none of the vendors currently offers tour products in that area: each route is intelligently generated to match the user's preference. Each route is fully customizable and ready to send request for quotations.

For example, the user may input a sentence to describe their request including: where he or she wants to go, how many days he or she wants to spend, how much his or her budget is, how many people are going for this trip. For example, a user is looking to book a tour for three days in Beijing in June. Next, the system will grasp the vital information such as days and destination, and match it with the user's preference pattern as well as the big data analytics results determined by the system, and then list all related top-ranking tour products. If the system doesn't find any related tour products offered by the registered vendors, it will intelligently generate several routes around that destination for the user to choose.

Each route may comprise several individual tours/activities as other tour products do, the only difference is that this product doesn't have any service providers associated with it. The system will help the user to get quotation from local travel service providers whom are searched out by the present search engine. The system will send an email to the qualified service providers for quotations.

The present invention may provide fully customizable functions on existing tour products and system-generated routes. This function helps a user to customize an existing tour product or route generated by the present system and search engine. A user may select or deselect tours and activities from existing tour products or system-generated route. Each time a user selects or deselects a tour and activity, an estimated real-time price and time change will be displayed. A user may also input his or her special request into the text field of the system.

When a service provider has already become a registered member, an intelligent quotation system may be provided to make the whole quotation process simple but smart by replying to a quotation request by email. When a user requests to customize a tour, the itinerary or package is already detailed and engaged into a simple contract for a service provider to follow. The service provider may then reply to the email with price. This process will dramatically save a service provider's time to respond to the user's specifications.

The system may include simple price comparing and one-click booking. The system may consolidate all quotations received from service providers into one email to an end user by listing: price, name of providers, detail itineraries, rankings, number of reviews, etc.

When the end user receives this email, he or she may simply compare all information in one email/table and choose one quote he/she likes the most by clicking the “confirm” button in the email, or go to the website to confirm this booking. The booking transaction is now finished (providing his credit card information which has been received by the system).

When a user first time logs in, the system will prompt some questions to get the user's travel preference ‘snapshot’. When a user is not the first-time-login client, the system will suggest tour products based on the user's preference combined with the results from big data analytics so that his/her home page always matches his/her tour preference. When a user clicks the search button on the home page with some keywords, for example, “Beijing tour for three days in June”, the system will show all related tour products and/or intelligently generate routes based on this person's tour preference. Each tour product comes from group registered vendor; each route is intelligently generated by the system. Each tour product is ready for instant booking, and it is also customizable to get a quotation. Each system-generated route can't be instantly booked but is able to be requested for quotation, and it is customizable to get a quotation.

When the user chooses to customize and get a quotation, full customization functions are applied. The client may drag and drop or select and deselect the specific tours and activities from the list, or input whatever his/her specifications are into the text field. During the client's selection and deselection, the estimated time range and estimated cost range will also be shown. After the client is happy about the result, then the client may choose to submit their request.

When the system receives the request, the system starts searching for related service providers in the database. On the backend, a web crawler continuously searches for tour service providers' information from the Internet, and saves information into the database.

When a new user logs into our App for the first time, the system will display several groups of pictures for the user to select (or several groups of questions). The purpose of this is to get the user's travel preference. When the user browses the App, each time the user browses any inside pages (cities, tours, etc.) or searches on our App, the system's backend will record each click of the page links or his/her searched items. Next, the system will analyze his/her activity to recognize a user's tour preference pattern. Each time when this user purchases a tour from the site, the system will record the transaction details and analyze his/her purchased tour product to get a more precise tour preference. Thus, when a new user or existing user logs into the App, his/her home page will show the tour products and routes that are matching this user's recent tour preference. If a user is an anonymous user (not a signed up user), the system's backend will use session ID to identify this person, and record this person's activity to the system each time he/she visits our system. Once an anonymous user has become a registered member, the system will link this anonymous user's preference records to his/her registered email account, so that all historical browsing records will be consolidated.

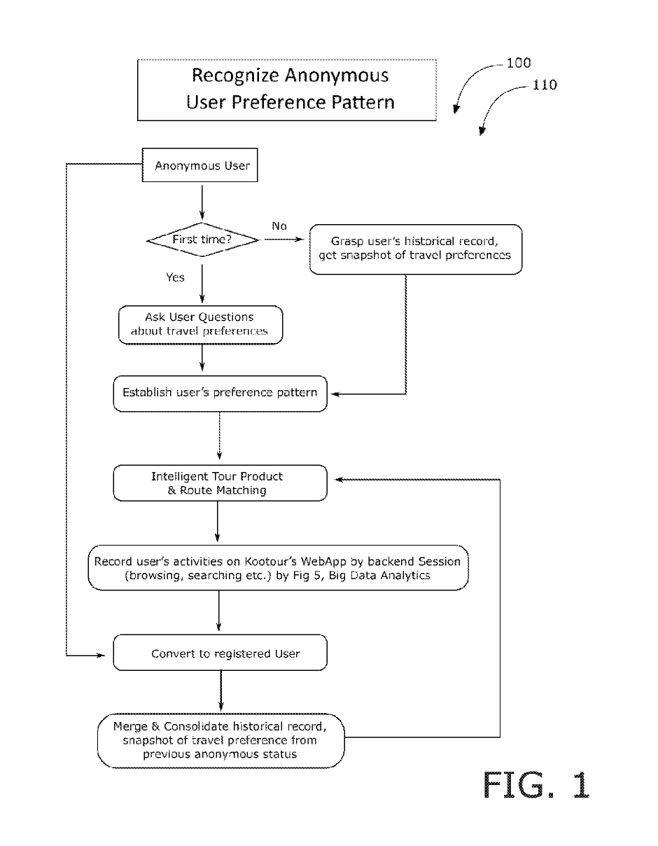

Referring now more specifically to the drawings by numerals of reference, there is shown in FIGS. 1-10, various flowcharts 110, 210, 310, 410, 510, 610, 710, 810, 910, and 1010, respectively, of a tour matching and generating system with method 100.

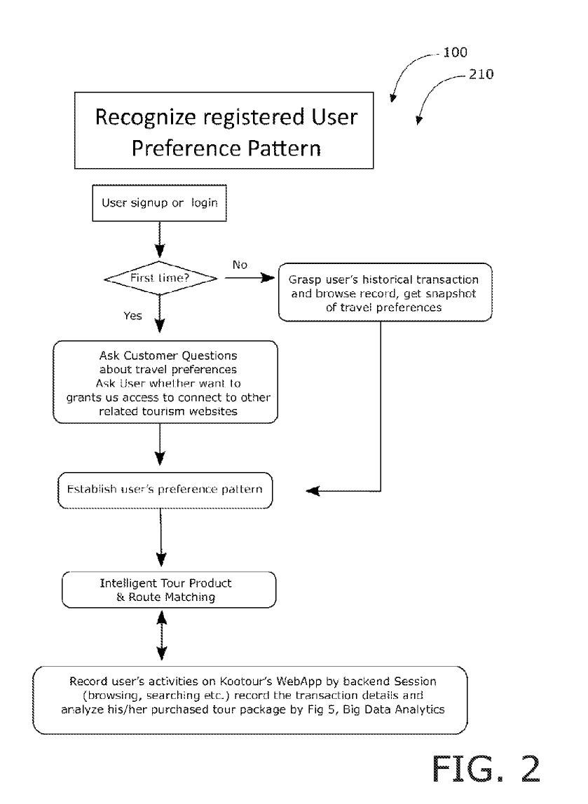

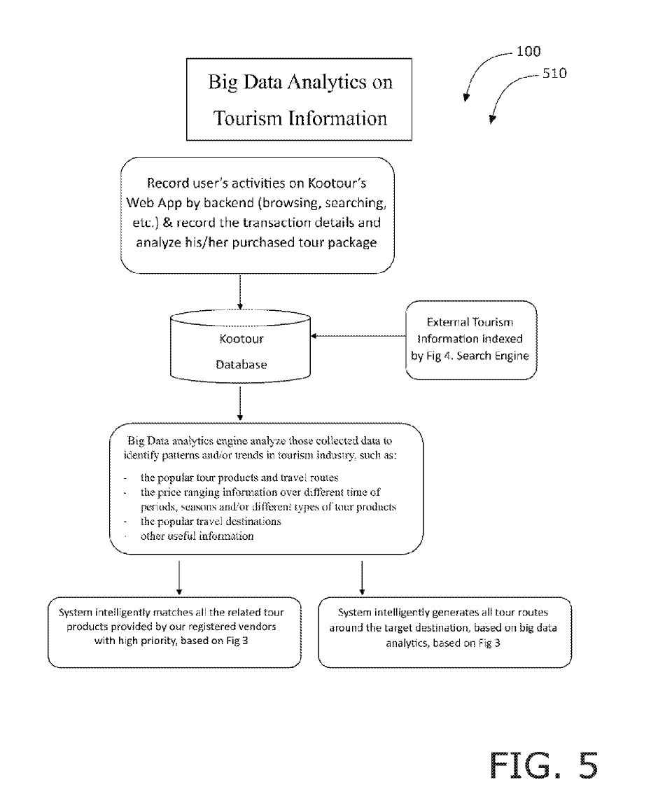

FIG. 1 and FIG. 2 show a process for tour matching and generating system with method 100 recognizing anonymous and registered user preference patterns according to an embodiment of the present disclosure. Referring now to FIG. 1, if the user is a first-time anonymous user the system will ask the user questions about travel preferences in order to establish user's preference pattern. If the user is an anonymous user however it is not their first time using the system, the system will grasp the user's historical records to get a snapshot of travel preferences. Using intelligent tour product and route matching system user activities are recorded on Kootour's App by backend Session (browsing, searching etc.) by Big Data Analytics as shown in FIG. 5. If a user converts into a registered user, records may then be merged and consolidated to create a snapshot of travel preference from previous anonymous status.

As shown in FIG. 2, the system is able to recognize registered user preference patterns. If the user is a first-time registered user the system will ask the user questions about travel preferences and ask the user to grant access to connect to other related tourism websites in order to establish user's preference pattern. If the user is a registered user however it is not their first time using the system, the system will grasp user's historical transaction and browsing records to get a snapshot of travel preferences. Using intelligent tour product and route matching system user activities are recorded on Kootour's App by backend session (browsing, searching etc.) by Big Data Analytics as shown in FIG. 5.

The user's purchase history and browsing history is able to be linked to a user account from other tourism websites. A tour product is created based on information supplied and user preference, tour products able to be customized by selecting and alternatively deselecting tours and activities from the tour product. Real-time price and time changes will be displayed as the user selects and alternatively deselects tours and activities from the tour product. Data store comprises airfare options, hotel options, and activity options which are able to be selectively combined to create a tour product. A web crawler is used to search and collect service provider's information and contact information of guides. The service provider receives a tour product quotation e-mail for bidding, the service provider being able to respond to the e-mail and provide at least one quotation. The quotations received from the service providers are consolidated into one e-mail to the user including price, name of providers, detailed itinerary, rankings, and number of reviews.

In another embodiment, keyword driven tour matching and generating system with method, the system comprises: a means for analyzing a user's purchase history, browsing history and keyword destination input, a means for analyzing tourism information collected from both user group activities and from internet sources, a data store that electronically stores information regarding tour products in response to one or more electronic queries, and a computing device in communication with the data store. User-preference driven tour matching and generating system collects the purchase history, the browsing history, and the keyword destination input to analyze from the data store and returns a plurality of quotes for preference-based-tours to a user for possible purchase.

When the user clicks a search button on a home page with some keywords, the system will show all related tour products based on the user's tour preference. The user is able to create a customized tour product and submit a request for a quote. The request for the quote must be quoted by a local tourism service provider within 24 or 48 hours. The quote(s) are automatically arranged and prioritized within an email to the user by price range and other criteria defined by the user. Tour product suggestions based on the user's preference combined with results from big data analytics appear on the user's home page when an account has been created. User-accounts are created for customized tour product creation.

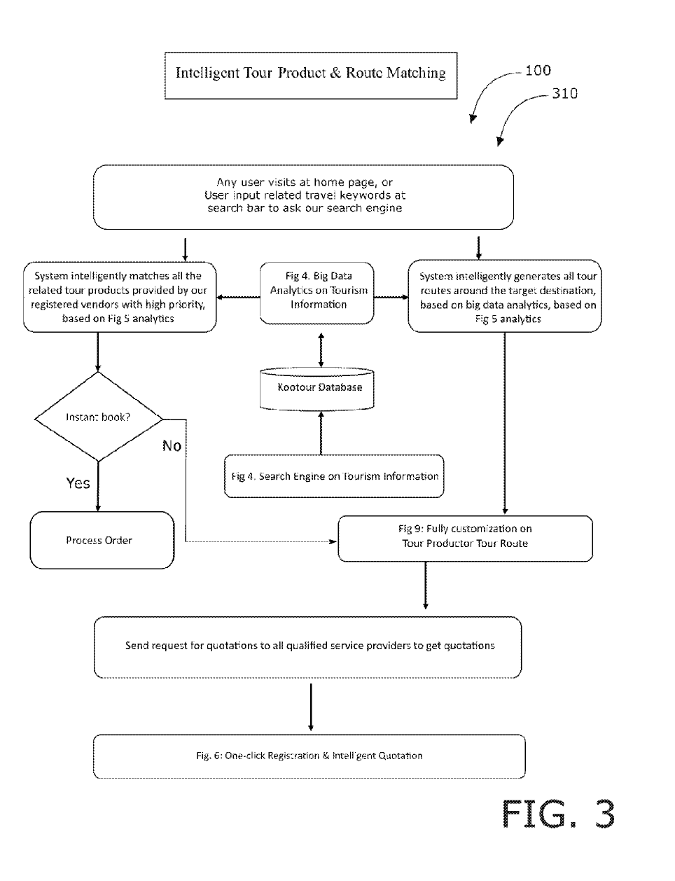

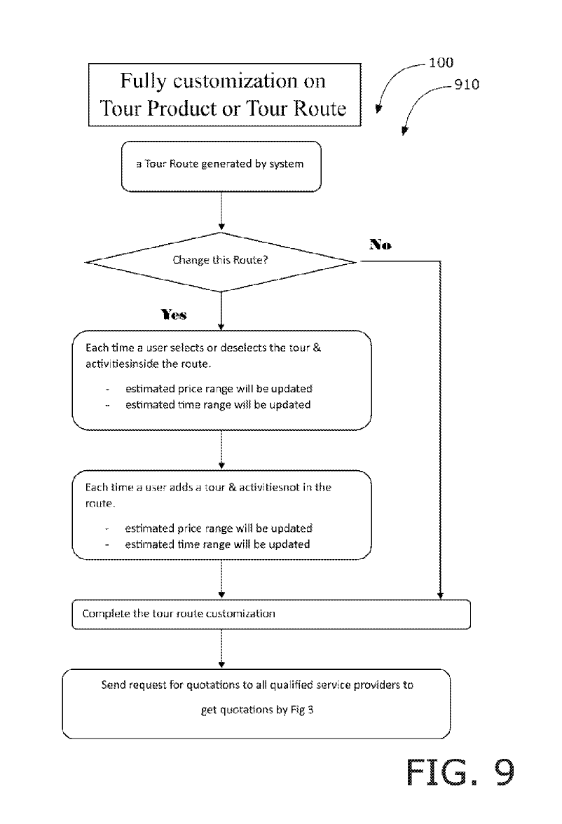

FIG. 3 is a diagram of the tour matching and generating system 100 of FIG. 1, including a process for intelligent tour product and route matching according to an embodiment of the present disclosure. If a user visits home page or user inputs related travel keywords in the search bar to ask the system, the system is able intelligently match all the related tour products provided by registered vendors with high priority, based on FIG. 5 analytics. A user may then either instantly book one of those tour products or choose to customize part of the tour, as shown in FIG. 9. If the user is satisfied with the presented tour products, user may then choose to instantly book for the tour products and the order will be processed. If the user chooses to customize part of the tour, the user may then send a request for quotations to all qualified service providers to get quotations. Alternatively, the system is able to intelligently generate all tour routes around a target destination, based on big data analytics, as shown in FIG. 5. A user may then fully customize a tour product or tour route, send a request for quotations to all qualified service providers to get quotations, and register using one-click registration and intelligent quotation.

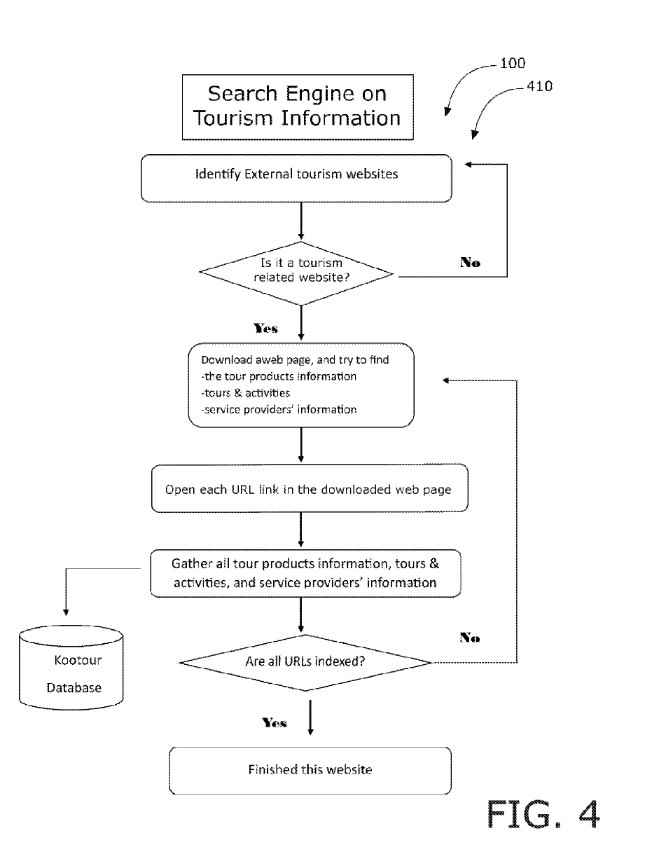

FIG. 4 is a diagram of a search engine on tourism information of the tour matching and generating system 100 of FIG. 1, according to an embodiment of the present disclosure. The steps include: sending out a web crawler and identifying external tourism websites which include many service providers' information; downloading a web page and try to find tour product information, tours and activities, and service providers' information (the easiest way is to match each field, email, phone, service description, etc.); opening each URL link in the downloaded web page; gathering all tour products information, tours and activities, and service providers' information; directing to Kootour Database. If all URLs are indexed, the system is finished with the website.

FIG. 5 is a diagram of the tour matching and generating system 100 of FIG. 1, using big data analytics on tourism information. Big data analytics includes a means for analyzing tourism information collected from both user group activities and from internet sources. The big data analytics feature involves a means for analyzing collected tourism information from both internal and external databases and identifying different patterns and/or trends on general population. The results obtained from big data analytics can be used for various purposes, including intelligent tour product matching and routes generating, content building such as writing blogs and newsletter to our members.

The system is able to record user's activities on Kootour's App by backend (browsing, searching, etc.) and record transaction details and analyze his or her purchased tour package. Big Data analytics engine analyzes collected data to identify patterns and/or trends in the tourism industry, such as: popular tour products and travel routes; price ranging information over different periods of time; seasons and/or different types of tour products; popular travel destinations; and other useful information. System intelligently matches all the related tour products provided by our registered vendors with high priority, based on FIG. 3. System intelligently generates all tour routes around the target destination, based on big data analytics, as shown in FIG. 3.

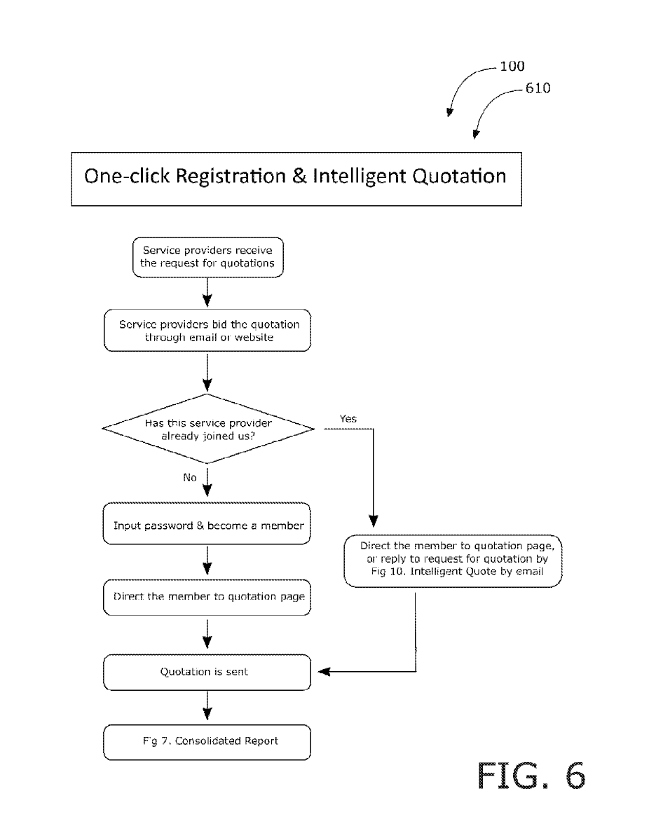

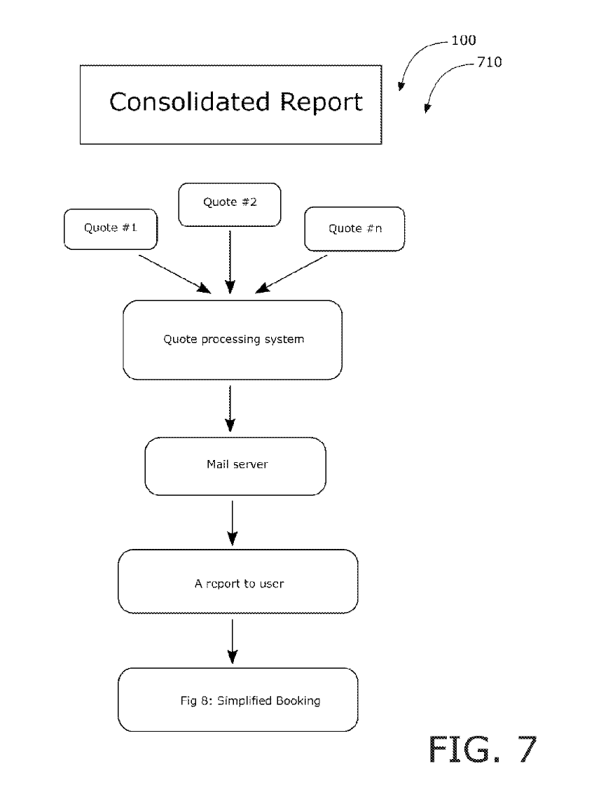

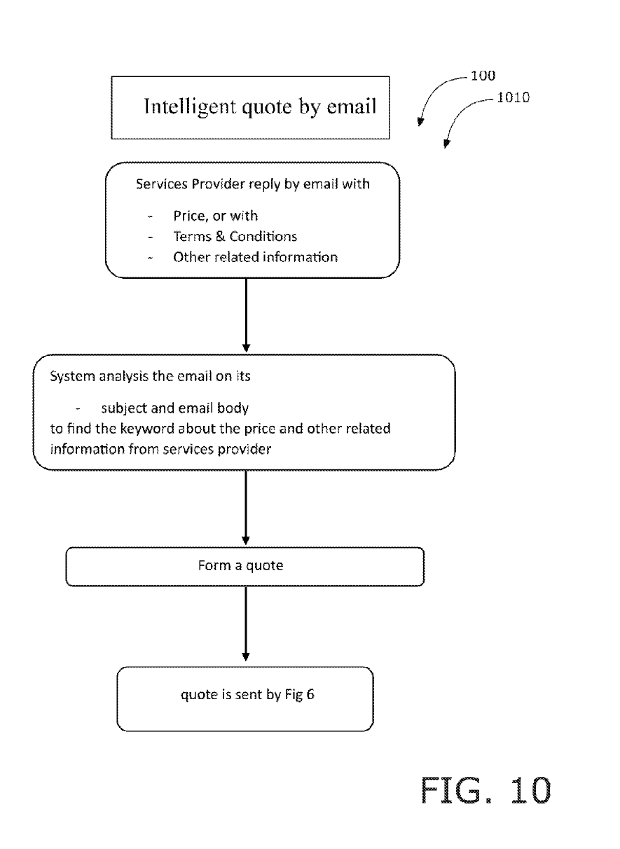

FIG. 6 is a diagram of one-click registration and intelligent quotation of the tour matching and generating system with method 100 of FIG. 1, according to an embodiment of the present disclosure. When a service provider receives a request for quotations, service providers may bid on the quotation through e-mail or the website. If the service provider has already joined as a member, the member will be directed to a quotation page or reply to the request for quotation as shown in FIG. 10. If the service provider is not a member, the service provider may input a password and become a member. The member may then be directed to the quotation page. Once a quotation is sent a consolidated report may be created as shown in FIG. 7. Those local tourism service providers who receive a request will quote for it and send back to the controlling entity of the system 100 within a certain timeframe of hours (within 24-48 hours).

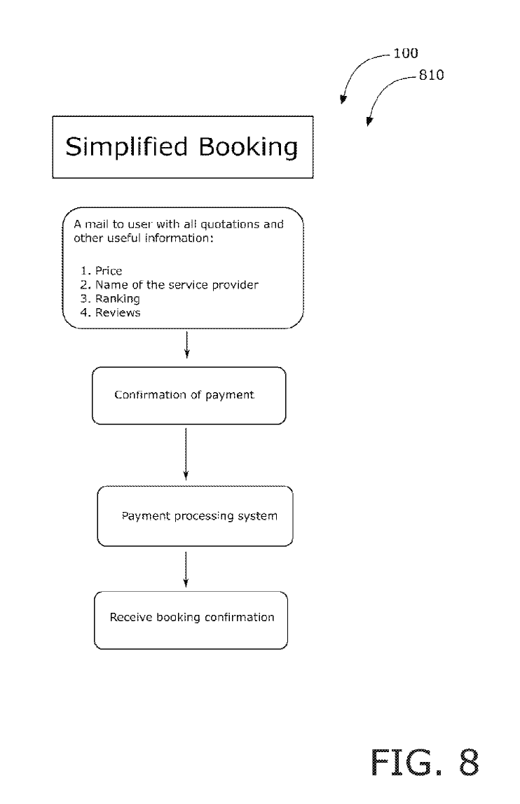

FIG. 7 is a diagram of the tour matching and generating system 100 of FIG. 1, creating a consolidated report according to an embodiment of the present disclosure. Quotations received from the service providers are sent through a quote processing system and consolidated into one e-mail to the user including price, name of providers, detailed itinerary, rankings, and number of reviews. A user may then book tours using simplified booking as shown in FIG. 8.

FIG. 8 is a diagram of the tour matching and generating system 100 of FIG. 1, having simplified booking according to an embodiment of the present disclosure. An e-mail is sent to a user with all quotations and other useful information including price, name of service provider, ranking, and reviews. Next, confirmation of payment is needed and payment processing system sends booking confirmation.

FIG. 9 is a diagram of the tour matching and generating system 100 of FIG. 1, including means for full customization on tour products or tour routes according to an embodiment of the present disclosure. Once a tour route is generated by the system a user is able to change the route. Each time a user selects or deselects the tour and activities inside the route estimated price range will be updated as well as estimated time range will be updated. Each time a user adds a tour and activities not in the route estimated price range will be updated as well as estimated time range will be updated. Once a user completes the tour route customization a request may be sent for quotations to all qualified service providers to get quotations according to FIG. 3.

FIG. 10 is a diagram of the tour matching and generating system 100 of FIG. 1, providing an intelligent quote by e-mail according to an embodiment of the present disclosure. Service providers may reply by e-mail with price, terms and conditions, and other related information. The system analyzes the e-mail by scanning the subject and e-mail body to find keywords about the price and other related information from the service provider. A quote may then be formed and sent using the mean displayed in FIG. 6.

A method is also disclosed for tour matching and generating system with method 100, according to an embodiment of the present disclosure. In particular, the method for intelligently booking tour products may include one or more components or features of the tour matching and generating system with method 100 as described above. As illustrated, the method for providing quotes for and booking tour products may include the steps of: entering data by a user over a duration to create a purchase history and browsing history; using the purchase history and the browsing history to create a user-profile; logging in to the user-profile to search for tour products based on keywords; customizing the tour products; requesting quotes for the tour products from members; receiving quotes for suggested the tour products to the user; and booking the tour product based on quotes.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for customizing tour products and requesting quotes from local tourism service providers (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A user-preference driven tour matching and generating system with method, the system comprising:
a means for analyzing a user's purchase history and browsing history;
a means for analyzing tourism information collected from a combination of both user group activities and from internet sources;
a data store that electronically stores information regarding tour products in response to one or more electronic queries;
a computing device in communication with the data store; and
wherein said user-preference driven tour matching and generating system collects said purchase history and browsing history to analyze from said data store and returns a plurality of quotes for preference-based-tours to a user for possible purchase.

2. The user-preference driven tour matching and generating system of claim 1, wherein a user preference pattern is established by recording user's activities on browsing and searching Kootour's App.

3. The user-preference driven tour matching and generating system of claim 1, wherein the user's purchase history and browsing history is able to be linked to a user account from other tourism websites and social accounts.

4. The user-preference driven tour matching and generating system of claim 1, wherein a tour product is created based on information supplied and user preference, tour products able to be customized by selecting and alternatively deselecting tours and activities from the tour product.

5. The tour matching and generating system of claim 4, wherein real-time price and time changes will be displayed as said user selects and alternatively deselects tours and activities from the tour product.

6. The tour matching and generating system of claim 1, wherein the data store comprises airfare options, hotel options, and activity options which are able to be selectively combined to create a tour product.

7. The tour matching and generating system of claim 1, wherein a web crawler is used to search and collect service provider's information and contact information of guides.

8. The tour matching and generating system of claim 1, wherein the service provider receives a tour product quotation e-mail for bidding, the service provider being able to respond to the e-mail and provide at least one quotation.

9. The tour matching and generating system of claim 1, wherein the quotations received from the service providers are consolidated into one e-mail to the user including price, name of providers, detailed itinerary, rankings, and number of reviews.

10. A keyword driven tour matching and generating system with method, the system comprising:
a means for analyzing a user's purchase history, browsing history, and keyword destination input;
a means for analyzing tourism information collected from both user group activities and from internet sources;
a data store that electronically stores information regarding tour products in response to one or more electronic queries; and
a computing device in communication with the data store; and
wherein said user-preference driven tour matching and generating system collects said purchase history, said browsing history, and said keyword destination input to analyze from said data store and returns a plurality of quotes for preference-based-tours to a user for possible purchase.

11. The tour matching and generating system of claim 10, wherein when the user clicks a search button on a home page with some keywords, said system will show all related tour products and tour routes based on the user's tour preference.

12. The tour matching and generating system of claim 10, wherein the user is able to create a customized tour product and submit a request for a quote.

13. The tour matching and generating system of claim 12, wherein the request for the quote must be quoted by a local tourism service provider within 24 hours.

14. The tour matching and generating system of claim 10, wherein the quote(s) are automatically arranged and prioritized within an email to the user by price range and criteria defined by the user.

15. The tour matching and generating system of claim 10, wherein tour product suggestions based on the user's preference and historical data appear on the user's home page when an account has been created.

16. The tour matching and generating system of claim 10, wherein user-accounts are created for customized tour product creation.

17. A method of use for a user-preference driven tour matching and generating system, the method comprising the steps of:
entering data by a user over a duration to create a purchase history and browsing history;
using said purchase history and said browsing history to create a user-profile;
logging in to said user-profile to search for tour products based on keywords;
customizing said tour products;
requesting quotes for said tour products from members;
receiving quotes for suggested said tour products to said user; and
booking said tour product based on quotes.

18. The method of claim 17, further comprising the steps of:
wherein members who have not registered in the system are able to create an account in the database and a quote-request.
